(19) United States
(12) Patent Application Publication
(10) Pub. No.: US 2026/0300763 A1
(43) Pub. Date: Oct. 1, 2026

(54) METHODS AND SYSTEMS FOR FACILITATING DECENTRALIZED MANAGEMENT OF A KNOWLEDGE GRAPH

(71) Applicant: Richard Gillespie, Norwich, CT (US)

(72) Inventor: Richard Gillespie, Norwich, CT (US)

(21) Appl. No.: 19/096,071

(22) Filed: Mar. 31, 2025

(51) Int. Cl. G06N 5/022

(52) U.S. Cl. CPC G06N 5/022

(57) ABSTRACT

The present disclosure provides a method for facilitating decentralized management of a knowledge graph. Further, the method may include receiving a domain data from a user device associated with a user. Further, the domain data corresponds to a subject matter within a domain. Further, the method may include analyzing the domain data. Further, the method may include generating a knowledge graph operation data based on the analyzing. Further, the knowledge graph operation data includes one or more of a creation data which may be configured for creating a knowledge graph data and an updation data which may be configured for updating the knowledge graph data. Further, the method may include executing one or more of the creating and the updating. Further, the method may include storing the knowledge graph operation data on a decentralized database.

### FIELD OF DISCLOSURE

The present disclosure generally relates to a field of data processing. More specifically, the present disclosure relates to methods and systems for facilitating decentralized management of a knowledge graph.

### BACKGROUND

The field of knowledge graph management has become increasingly important in recent years as organizations seek to integrate, organize, and utilize vast amounts of data across diverse domains. Knowledge graphs, which represent structured and interconnected information, are critical for enabling semantic search, decision-making, and intelligent applications. These systems are utilized in various industries, including finance, healthcare, education, and technology, to manage complex relationships between entities, such as people, places, concepts, and events.

Existing knowledge graph management systems face significant challenges. One primary issue is the lack of robust mechanisms for ensuring data integrity and authenticity. Without reliable methods for validating changes or transactions, organizations risk suffering data breaches, fraud, or misinterpretation of information. Additionally, traditional approaches to knowledge graph management often lack transparency, making it difficult to trace the origin or history of data updates, which can lead to accountability issues.

Another critical challenge is the need for efficient and ethical governance of knowledge graphs. As knowledge graphs grow in size and complexity, managing ethical standards, transformation parameters, and domain-specific guidelines becomes increasingly complex. Existing systems often lack mechanisms for real-time collaboration among domain experts, leading to delays, inconsistencies, or poorly informed decisions.

Further, the existing systems lack mechanisms for storing knowledge graph in a verifiable and human-readable format, dynamically generating transformation agents based on real-time training data and adaptive audit feedback, validating candidate output against ethical and moral standards via foundational ethics node, recording every transaction on an immutable block-chain sidechain and enabling decentralized governance for real-time collaborative update.

Moreover, the scalability and monetization of knowledge graph access pose additional challenges. Many knowledge graph platforms struggle with balancing accessibility with security, often requiring costly subscriptions or licenses that limit adoption. Additionally, traditional licensing models may not align with the dynamic nature of knowledge graphs, where usage patterns can vary significantly over time.

Therefore, there is a need for improved methods and systems for facilitating a decentralized management of a knowledge graph, that may overcome one or more of the above-mentioned problems and/or limitations.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method for facilitating decentralized management of a knowledge graph. Further, the method may include receiving, using a communication device, a domain data from a user device associated with a user. Further, the domain data corresponds to a subject matter within a domain. Further, the method may include analyzing, using a processing device, the domain data. Further, the method may include generating, using the processing device, a knowledge graph operation data based on the analyzing. Further, the knowledge graph operation data includes one or more of a creation data which may be configured for creating a knowledge graph data and an updation data which may be configured for updating the knowledge graph data. Further, the method may include executing, using the processing device, one or more of the creating and the updating. Further, the method may include storing, using a storage device, the knowledge graph operation data on a decentralized database.

The present disclosure provides a system for facilitating decentralized management of a knowledge graph. Further, the system may include a communication device. Further, the communication device may be configured for receiving a domain data from a user device associated with a user. Further, the domain data corresponds to a subject matter within a domain. Further, the system may include a processing device communicatively coupled with the communication device. Further, the processing device may be configured for analyzing the domain data. Further, the processing device may be configured for generating a knowledge graph operation data based on the analyzing. Further, the knowledge graph operation data includes one or more of a creation data which may be configured for creating a knowledge graph data and an updation data which may be configured for updating the knowledge graph data. Further, the processing device may be configured for executing one or more of the creating and the updating. Further, the system may include a storage device which may be configured for storing the knowledge graph operation data on a decentralized database.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 for facilitating decentralized management of a knowledge graph, in accordance with some embodiments.

FIG. 4 illustrates a flowchart of a method 400 for facilitating decentralized management of a knowledge graph including generating, using the processing device 1204, a response data, in accordance with some embodiments.

FIG. 5 illustrates a flowchart of a method 500 for facilitating decentralized management of a knowledge graph including retraining, using the processing device 1204, the transformation agent, in accordance with some embodiments.

FIG. 6 illustrates a flowchart of a method 600 for facilitating decentralized management of a knowledge graph including retraining, using the processing device 1204, the transformation agent, in accordance with some embodiments.

FIG. 7 illustrates a flowchart of a method 700 for facilitating decentralized management of a knowledge graph including retraining, using the processing device 1204, the transformation agent, in accordance with some embodiments.

FIG. 8 illustrates a flowchart of a method 800 for facilitating decentralized management of a knowledge graph including analyzing, using the processing device 1204, the validation data, in accordance with some embodiments.

FIG. 9 illustrates a flowchart of a method 900 for facilitating decentralized management of a knowledge graph including generating, using the processing device 1204, an agent data, in accordance with some embodiments.

FIG. 10 illustrates a flowchart of a method 1000 for facilitating decentralized management of a knowledge graph including generating, using the processing device 1204, a reward data, in accordance with some embodiments.

FIG. 11 illustrates a flowchart of a method 1100 for facilitating decentralized management of a knowledge graph including generating, using the processing device 1204, a signature data, in accordance with some embodiments.

FIG. 12 illustrates a block diagram of a system 1200 for facilitating decentralized management of a knowledge graph, in accordance with some embodiments.

FIG. 13 illustrates a flowchart of a method 1300 for facilitating decentralized management of a knowledge graph including generating, using the processing device 1204, a time data, in accordance with some embodiments.

FIG. 14 illustrates a flowchart of a method 1400 for facilitating decentralized management of a knowledge graph including generating, using the processing device 1204, a configuration data, in accordance with some embodiments.

FIG. 15 illustrates a flowchart of a method 1500 for facilitating decentralized management of a knowledge graph including generating, using the processing device 1204, a cost data, in accordance with some embodiments.

FIG. 16 illustrates a flowchart of a method 1600 for facilitating decentralized management of a knowledge graph including generating, using the processing device 1204, an access token data, in accordance with some embodiments.

FIG. 17 illustrates a flowchart of a method 1700 for facilitating decentralized management of a knowledge graph including analyzing, using the processing device 1204, the access token data, in accordance with some embodiments.

FIG. 18 illustrates a flowchart of a method 1800 for facilitating decentralized management of a knowledge graph including retrieving, using the processing device 1204, the transformation agent from a plurality of transformation agents, in accordance with some embodiments.

FIG. 19 illustrates a flowchart of a method 1900 for facilitating decentralized management of a knowledge graph including training, using the processing device 1204, the transformation agent, in accordance with some embodiments.

FIG. 20 illustrates a system architecture, in accordance with some embodiments.

FIG. 21 illustrates a flowchart of decentralized management of a knowledge graph, in accordance with some embodiments.

FIG. 22 illustrates a top node schematic of decentralized management of a knowledge graph, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes a decentralized, block-chain audited knowledge graph ecosystem with dynamic agent generation, adaptive token-based licensing, and foundational ethics self-validation for safe AI and multi-domain applications.

Further, the present disclosure describes a system and method for secure, decentralized management of knowledge graphs (KGs). The system and method integrates block-chain audited digital signatures, dynamic token-based licensing, decentralized governance, and an adaptive foundational ethics module to create human-readable, auditable, and self-evolving KGs. Further, the key feature includes a dynamic agent generation framework, wherein transformation agents whose executable code is stored within the KG are dynamically loaded, refined, and combined in real time to generate candidate solutions for abstract puzzles, complex mathematical problems, and ethical language games.

Further, candidate outputs are evaluated by a foundational ethics node that employs Aristotelian logic, Socratic dialectic inquiry, and Wittgensteinian language games to ensure ethical compliance. All transactions, transformation events, and governance actions are cryptographically hashed and recorded on a block-chain sidechain, providing transparent, immutable audit trails. Also, complex challenges found in abstract puzzles, mathematical proofs, and ethical dilemmas demand multifaceted, dynamic processing.

Further, an integrated language model backup supplies fallback solutions and natural language explanations, thereby safeguarding against rogue AI. The system establishes a monetizable, continuously adaptive framework applicable to diverse, high-risk domains.

The following are the components of the system and method for managing knowledge graph:

### 1. Blockchain-Audited Data Integrity and Dynamic Licensing:

Every update to the KG is digitally signed, timestamped, and aggregated using secure algorithms (e.g., SHA-256). The resulting hash is recorded on a block-chain sidechain, ensuring immutable, publicly verifiable audit trails. Token costs are dynamically computed based on real-time usage and transformation complexity, and smart contracts automatically process microtransactions to provide transparent, scalable revenue sharing.

### 2. Dynamic Transformation Agent Generation:

Transformation agents are stored as executable code (e.g., Groovy scripts) along with configuration data and performance metrics. Further, the transformation agents are dynamically retrieved, compiled, and instantiated by a Dynamic Agent Manager using a secure scripting engine. Adaptive learning driven by audit feedback and performance metrics continuously refines these agents and generates new combinations to address complex challenges.

### 3. Foundational Ethics Self-Validation:

A central ethics node, constructed at system initialization, aggregates ethical concepts, moral dilemmas, logical fallacies, and sample arguments. Employing Aristotelian logic, Socratic dialectic inquiry, and Wittgensteinian language games (which abstract the notion of shared internal dialogue), the ethics node evaluates candidate outputs. Further, outputs conforming to ethical standards are auto-approved; those posing significant ethical concerns are flagged for further adaptive refinement and expert review.

### 4. Decentralized Governance and Adaptive Learning:

Domain experts participate in a distributed voting process to update ethical standards and transformation parameters in real time. Governance events, together with performance and audit data, are recorded on the block-chain. This continuous feedback loop drives adaptive learning, ensuring the system evolves based on real-world performance and ethical evaluations.
   5. Hybrid Integration with LLM Backup and Interoperability:
An integrated language model backup provides fallback solutions and natural language interpretations, converting plain language queries into actionable Cypher commands. The system is engineered for seamless interoperability with external APIs and enterprise architectures, ensuring long-term scalability and adaptability.

### DETAILED DESCRIPTION

### 1. System Architecture:

The system is implemented as a Neo4j plugin with fully Java-and Groovy-based components, comprising the following modules:
Knowledge Graph Database (KG):
   The KG stores domain-specific data as human-readable nodes and relationships. Each update is digitally signed and timestamped;
   transactions are aggregated and hashed.
Digital Signature and Blockchain Module:
   A Digital Signature Util signs data using RSA. A Transaction Aggregator and Hash Calculator compute secure SHA-256 hashes, which are recorded on a block-chain sidechain via Blockchain Connector and Smart Contract Handler (using an Ethereum-compatible network and web3j), ensuring tamper-proof audit trails. Further, uses PKI (such as RSA or ECC) to generate digital signatures for each KG transaction, ensuring data integrity and accountability.
Dynamic Licensing Module:
   A Token Pricing Engine dynamically computes token costs based on real-time usage and transformation complexity. Revenue Sharing Manager and Licensing Procedures expose these metrics and process microtransactions via smart contracts, enabling equitable revenue sharing. It integrates with smart contracts, to automatically manage token transfers for both awarding tokens to domain experts and deducting tokens from users accessing the knowledge graphs.
Foundational Ethics Node and Self-Validation:
   Built at initialization, the Ethics Node comprises nodes for Ethical Concepts, Moral Dilemmas, Logical Fallacies, and sample Arguments. An Ethics Validator evaluates candidate outputs from transformation agents against these standards using a multi-agent framework that combines Aristotelian logic, Socratic dialectic inquiry, and Wittgensteinian language games. Adaptive learning mechanisms refine the evaluation process based on audit feedback.
Adaptive Transformation Agent Engine:
   Transformation agent definitions including executable Groovy code, configuration data, and performance metrics are stored in the KG. The Dynamic Agent Manager retrieves, compiles, and instantiates these agents via a secure scripting engine. Further, the continuous monitoring of performance and audit logs drives adaptive learning, resulting in the dynamic generation and refinement of agent combinations.
Learning Module and LLM Backup:
   The Learning KG Manager builds foundational KGs (such as an ARC Puzzle KG and a Math KG) at startup. Puzzle Solver ingests puzzles from training and evaluation datasets and logs performance outcomes for continuous adaptation. Conversational Agent and LLM Backup Client provide fallback natural language explanations and convert plain language queries into Cypher commands.
Decentralized Governance:
   Governance Procedures and Vote Manager implement a distributed voting process that allows domain experts to update ethical standards and transformation parameters. All governance actions are recorded on the block-chain, ensuring transparency and accountability. Further, the voting mechanism allows the domain experts to validate, curate, and update their published knowledge graphs, thereby maintaining human oversight
Interoperability and Extensibility:
   The system is designed to integrate seamlessly with external APIs, data formats, and enterprise software, ensuring that the ecosystem remains scalable and adaptable to future technological advances.
Blockchain-Enabled Microtransactions:
   Each KG update, transformation event, and governance action triggers smart contract interactions that process dynamic token-based licensing and revenue sharing. This monetizable framework incentivizes innovation and ensures that every interaction is securely logged.
   Further, the system aggregates KG transactions over defined periods, computes a cryptographic hash, and synchronizes this hash with a block-chain sidechain to create an immutable audit record.
Secure Authentication System:
   Implements multi-factor authentication (e.g., OAuth 2.0) and links user identities to block-chain wallets to ensure secure token transactions and access control.
Training and Instructional Platform:
   An integrated training system that enhances the ARC Language Game inner dialog schema. This system allows domain experts to learn how to create and support their domain-specific KGs, ensuring that they can build, evolve, and monetize their own knowledge assets.

### 2. Workflow:

Initialization:
   The system initializes by executing the Main Plugin, which registers all custom procedures, builds foundational KGs, and deploys smart contracts for dynamic licensing at minimal fees. The Dynamic Agent Manager retrieves transformation agent definitions from the KG and instantiates them.
Puzzle Ingestion and Processing:
   Puzzles are ingested from training and evaluation datasets. The Dynamic Agent Manager applies transformation agents to generate candidate solutions, which are validated against the foundational Ethics Node. Non-compliant outputs trigger adaptive refinement through audit feedback and decentralized governance.
Ethical Validation and Adaptive Learning:
   The Ethics Validator reviews candidate outputs using a multi-agent reasoning framework. Adaptive Ethics Learning Agent updates internal parameters based on continuous audit feedback. Domain experts participate in decentralized governance to vote on necessary changes, with all governance events recorded on the block-chain.
User Interaction and Hybrid Integration:
   End users and domain experts interact with the system via Cypher queries or natural language interfaces. The integrated LLM backup provides fallback solutions and human-readable chain-of-thought explanations.
Continuous Improvement:
   Performance metrics, audit logs, and governance events feed into a continuous improvement loop, allowing the dynamic update of transformation agents, ethical evaluation criteria, and licensing models.

### 3. Key Aspects:

1. A method for secure, decentralized management of knowledge graphs, comprising:
   Storing data in a human-readable KG with digital signatures and block-chain backed immutable audit trails;
   Dynamically generating transformation agents based on real-time training data and adaptive audit feedback; and
   Enforcing dynamic token-based licensing via smart contracts.
   Further, the transformation agents are stored as executable code in the KG and are dynamically retrieved, compiled, and instantiated by a Dynamic Agent Manager using a secure scripting engine, with continuous refinement driven by performance metrics and audit logs.
   Further, the method includes a foundational ethics node that evaluates candidate outputs using Aristotelian logic, Socratic dialectic inquiry, and language game abstractions, automatically approving compliant outputs and flagging non-compliant outputs for expert review.
   Further, the method includes a decentralized governance process wherein domain experts collaboratively update ethical standards and transformation parameters via a distributed voting mechanism recorded on a block-chain.
   Further, the method integrates with a fallback language model to provide natural language explanations and convert plain language queries into actionable Cypher commands.
   Further, the method performs dynamic token-based licensing, wherein token costs are computed based on real-time usage metrics and transformation complexity, and microtransactions are processed via smart contracts.
   Further, the computer-readable storage medium containing instructions which, when executed by a processor, perform at least one of the above mentioned process.
2. A method for validating and monetizing domain-specific knowledge graphs, comprising:
   Creating a foundational Ethics Node that stores ethical principles, moral dilemmas, and sample arguments;
   Generating candidate outputs via multiple transformation agents and dynamically combining them to optimize solution accuracy;
   Validating outputs against ethical standards and recording all validation events on a block-chain sidechain for immutable auditability; and
   Enforcing dynamic token-based licensing for access to the learning module via smart contracts.
   Further, the domain experts participate in a decentralized governance process to update ethical standards and system parameters, with all governance events recorded on the block-chain.
3. A method for incentivizing continuous learning in knowledge graph management, comprising:
   Ingesting data from training and evaluation datasets;
   Processing data using dynamically generated transformation agents;
   Logging performance outcomes and audit feedback in the KG;
   Automatically refining and generating new transformation agents based on logged performance data; and
   Distributing revenue through dynamic token-based licensing via smart contracts.
4. A method for safeguarding against rogue AI by integrating a foundational Ethics Node that continuously validates all outputs generated by dynamic transformation agents and enforces a decentralized governance process for real-time ethical oversight.

The system may offer a transparent, auditable, and continuously evolving solution for diverse, high-risk domains.

Further, the system is designed to empower domain experts to create, maintain, and monetize their own domain-specific knowledge graphs (KGs). It combines several advanced technologies to offer a decentralized ecosystem where:
Domain experts (or “authors”) use an AI-assisted process (abstractly represented as an “AI puzzle solving” mechanism) to generate and refine their knowledge graphs.
Each interaction with the knowledge graph is secured through digital signatures, ensuring authenticity and traceability.
The system periodically aggregates and commits cryptographic hashes of these transactions to a block-chain sidechain, creating an immutable, tamper-proof audit trail.
Access to these published knowledge graphs is regulated through a dynamic token-based licensing mechanism; users pay tokens to access the data, and the tokens are automatically redistributed to the contributing experts.
A decentralized governance framework enables continuous human oversight, ensuring that the technology remains safe and AI is used as a supportive, human-centric tool rather than an autonomous decision-maker.

The system operates by integrating multiple layers of technology into a unified ecosystem:
1. Digital Signing and Data Integrity:
   Every update or transaction within the knowledge graph is digitally signed using robust public key infrastructure (PKI). This ensures that each action is authenticated and timestamped.
2. Blockchain Synchronization:
   A middleware layer periodically aggregates these digitally signed transactions and computes a cryptographic hash (e.g., via SHA-256). This hash is then committed to a block-chain sidechain (using an Ethereum-compatible protocol), providing a secure, decentralized record that guarantees data immutability without impacting real-time operations.
3. Dynamic Token-Based Licensing:
   The system includes a licensing module that evaluates usage metrics and transformation parameters to dynamically compute token costs for accessing the knowledge graphs. Smart contracts automatically manage token transfers, rewarding authors when users access their data.
4. Secure Authentication:
   The system employs a secure user authentication mechanism (e.g., OAuth 2.0 combined with multi-factor authentication) that links verified user identities to blockchain wallets, ensuring that all transactions and access rights are traceable.
5. Decentralized Governance:
   A decentralized decision-making process (resembling a DAO) allows domain experts to collectively manage, curate, and update their knowledge graphs. This maintains a human-centric approach to AI and prevents centralized control.

Further, domain experts engage with an AI-assisted training system that guides them in solving conceptual puzzles related to their field. As they input and modify data, the knowledge graph database captures each transaction. Simultaneously, the digital signature module signs every update, ensuring that each piece of information is authentic and traceable.

Further, the middleware layer continuously monitors the KG database for new transactions. At predetermined intervals, it aggregates these transactions and computes a secure cryptographic hash. This hash is then transmitted and committed to a block-chain sidechain, creating an immutable audit trail without interrupting the performance of the live system.

Further, the token-based licensing module dynamically assesses how frequently and extensively the knowledge graph is accessed or transformed. Based on these metrics, it calculates token costs. When users access the KGs, smart contracts automatically deduct the requisite tokens from their linked block-chain wallets and credit the tokens to the domain experts'wallets.

Further, the authentication system ensures that every user accessing the system is verified through multi-factor authentication. This verified access links directly to block-chain wallets for seamless token transactions. Additionally, a decentralized governance module empowers domain experts to collaboratively manage and refine their taniners, ensuring that decisions about updates or licensing terms are made collectively.

Further, the system provides instructional content, interactive tutorials, and best-practice guidelines that help domain experts understand how to build and optimize their knowledge graphs. As experts gain experience, they can iteratively improve their taniners, using feedback from the decentralized governance process to refine their models further.

Further, the system may integrate quantum-resistant hashing algorithms, such as those based on lattice cryptography, to ensure that digital signatures remain secure against future cryptographic advancements. This feature addresses the technical problem of potential vulnerabilities in traditional hash functions by leveraging post-quantum cryptographic methods. In some embodiments, SHA-256 may be replaced with a lattice-based hash function like BLS (Boneh-Shoup).

Further, the system may incorporate biometric data to enhance key management scalability. This implementation allows users to establish cryptographic keys using fingerprints or facial recognition, reducing the reliance on traditional password-based systems and enhancing security. In some embodiments, multi-factor authentication (MFA) may be integrated with biometric verification for added layers of protection.

Further, the system may include a dynamic consent module to enable users to grant or revoke access dynamically. This feature addresses the technical problem of data privacy by allowing users to control which parts of their knowledge graph data are accessible. In some embodiments, this module may use decentralized identifiers (DIDs) to enable self-sovereign identity management.

Further, the system may employ AI-driven anomaly detection to identify suspicious activities in real-time. This feature improves system reliability by detecting potential breaches or unauthorized access before they occur. In some embodiments, machine learning models may be trained on historical transaction data to predict and flag unusual patterns.

Further, the cross-chain compatibility may be integrated to allow the block-chain-audited digital signature system to operate across different block-chains. This feature addresses the technical problem of interoperability by enabling seamless integration with various block-chain networks, such as Bitcoin, Ethereum, and Tezos. In some embodiments, a Layer 2 solution may be used to bridge different chains while maintaining security.

Further, the system may leverage distributed ledger technology to enhance resilience against attacks. This feature improves fault tolerance by ensuring that no single point of failure can disrupt the network. In some embodiments, the knowledge graph database may be replicated across multiple nodes with automatic failover mechanisms.

Further, the system may include a peer-to-peer governance module to enable community-driven decision-making. This feature improves collaboration by allowing domain experts and users to vote on updates or ethical standards collectively. In some embodiments, this module may use a distributed ledger to record votes and ensure accountability.

Further, the system may employ privacy-preserving data aggregation techniques to protect sensitive information during knowledge graph updates. This feature improves data privacy by ensuring that aggregated data does not reveal individual user identities. In some embodiments, homomorphic encryption may be used to perform calculations on encrypted data without decrypting it.

Further, an adaptive performance optimization may be implemented to dynamically adjust system resources based on usage patterns. This feature improves scalability by allocating computing power and bandwidth only when needed. In some embodiments, AI-driven algorithms may predict peak usage times and preemptively scale resources.

Further, the system facilitates multi-stakeholder collaboration support to facilitate teamwork across domains. This feature improves decision-making by enabling multiple parties to contribute and validate updates or governance decisions. In some embodiments, a collaborative workspace may be created where stakeholders can review and approve changes using digital signatures.

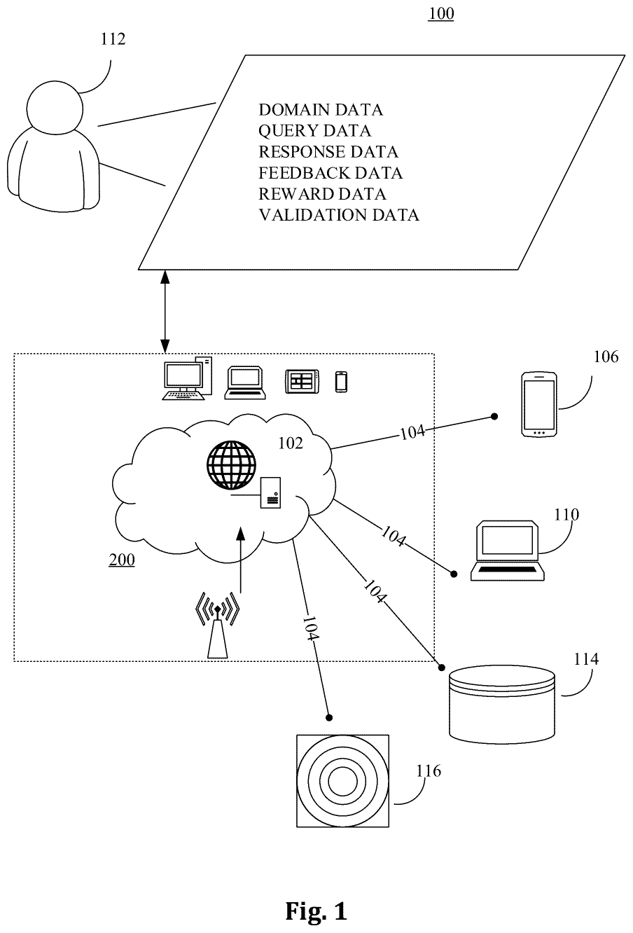

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

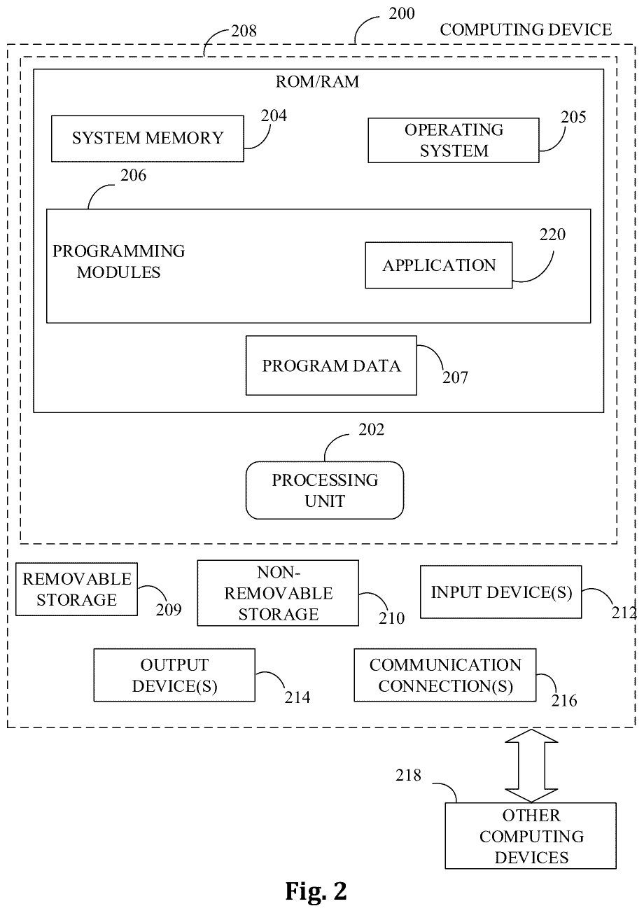

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods'stages may be modified in any manner, including by reordering stages and/or inserting or deleting stages, without departing from the disclosure.

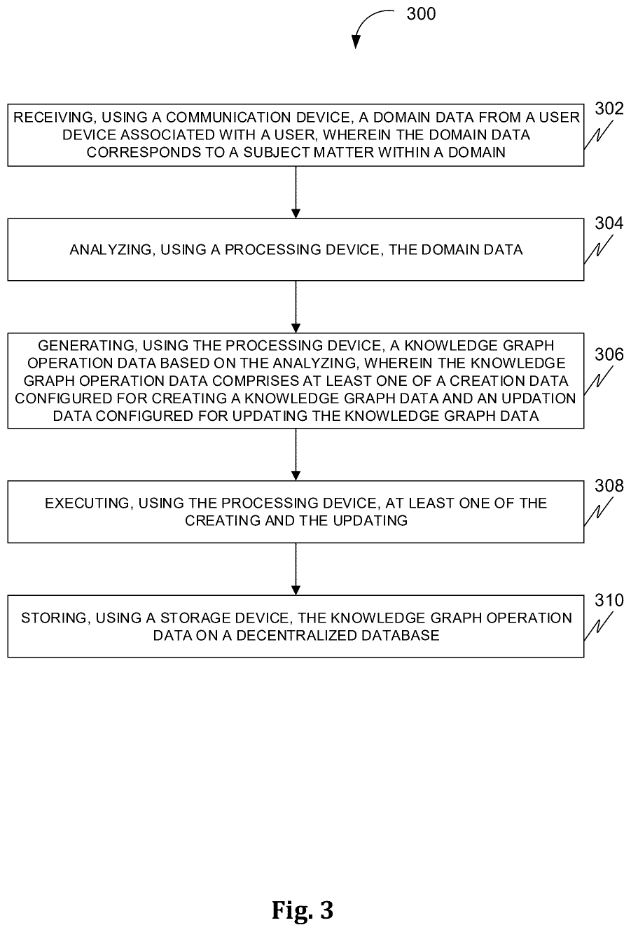

FIG. 3 illustrates a flowchart of a method 300 for facilitating decentralized management of a knowledge graph, in accordance with some embodiments.

Accordingly, the method 300 may include a step 302 of receiving, using a communication device 1202, a domain data from a user device associated with a user. Further, the domain data corresponds to a subject matter within a domain. Further, the method 300 may include a step 304 of analyzing, using a processing device 1204, the domain data. Further, the method 300 may include a step 306 of generating, using the processing device 1204, a knowledge graph operation data based on the analyzing. Further, the knowledge graph operation data includes one or more of a creation data which may be configured for creating a knowledge graph data and an updation data which may be configured for updating the knowledge graph data. Further, the method 300 may include a step 308 of executing, using the processing device 1204, one or more of the creating and the updating. Further, the method 300 may include a step 310 of storing, using a storage device 1206, the knowledge graph operation data on a decentralized database.

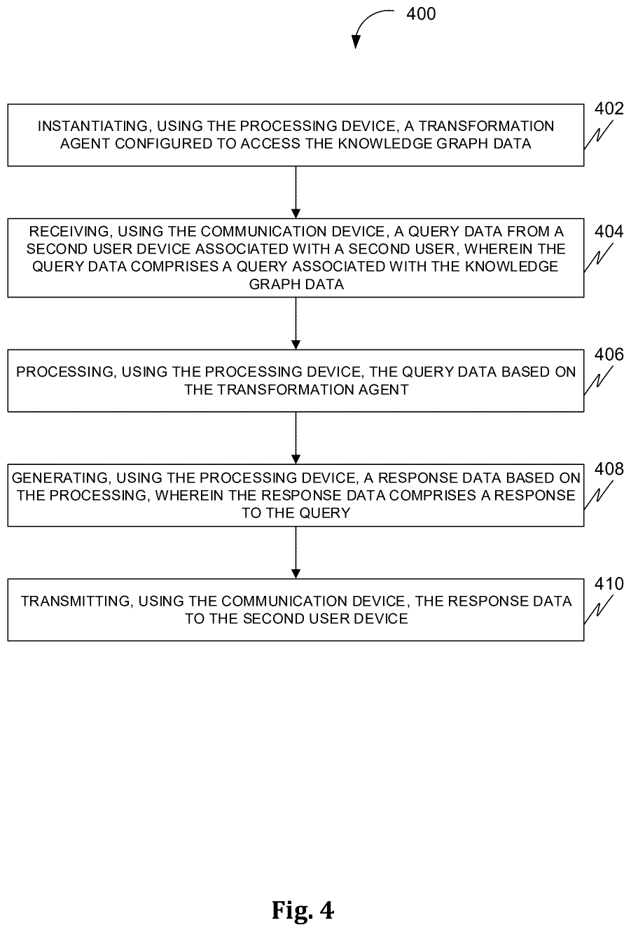

FIG. 4 illustrates a flowchart of a method 400 for facilitating decentralized management of a knowledge graph including generating, using the processing device 1204, a response data, in accordance with some embodiments.

Further, in some embodiments, the method 400 further may include a step 402 of instantiating, using the processing device 1204, a transformation agent which may be configured to access the knowledge graph data. Further, in some embodiments, the method 400 further may include a step 404 of receiving, using the communication device 1202, a query data from a second user device associated with a second user. Further, the query data includes a query associated with the knowledge graph data. Further, in some embodiments, the method 400 further may include a step 406 of processing, using the processing device 1204, the query data based on the transformation agent. Further, in some embodiments, the method 400 further may include a step 408 of generating, using the processing device 1204, a response data based on the processing. Further, the response data includes a response to the query. Further, in some embodiments, the method 400 further may include a step 410 of transmitting, using the communication device 1202, the response data to the second user device.

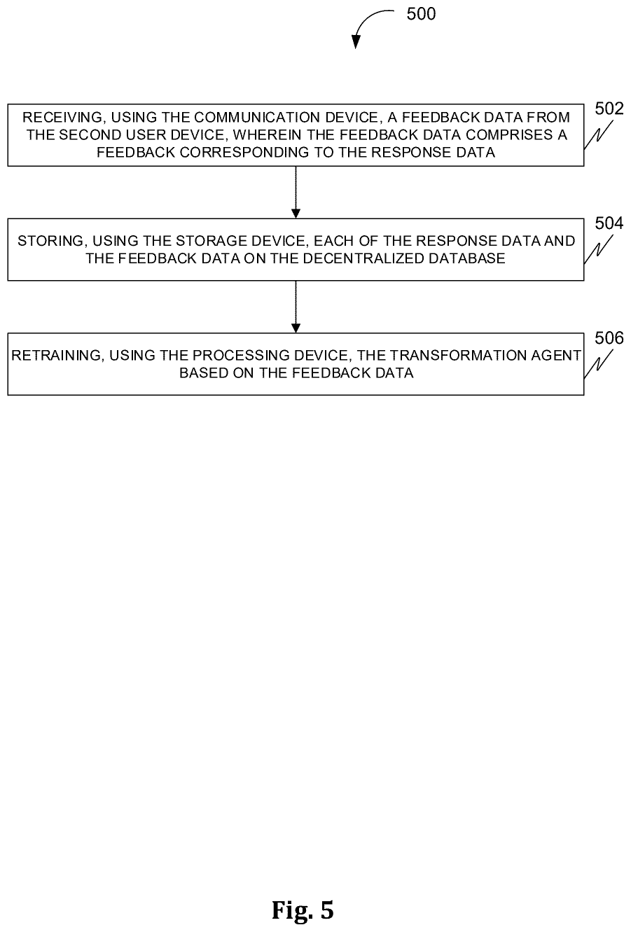

FIG. 5 illustrates a flowchart of a method 500 for facilitating decentralized management of a knowledge graph including retraining, using the processing device 1204, the transformation agent, in accordance with some embodiments.

Further, in some embodiments, the method 500 further may include a step 502 of receiving, using the communication device 1202, a feedback data from the second user device. Further, the feedback data includes a feedback corresponding to the response data. Further, in some embodiments, the method 500 further may include a step 504 of storing, using the storage device 1206, each of the response data and the feedback data on the decentralized database. Further, in some embodiments, the method 500 further may include a step 506 of retraining, using the processing device 1204, the transformation agent based on the feedback data.

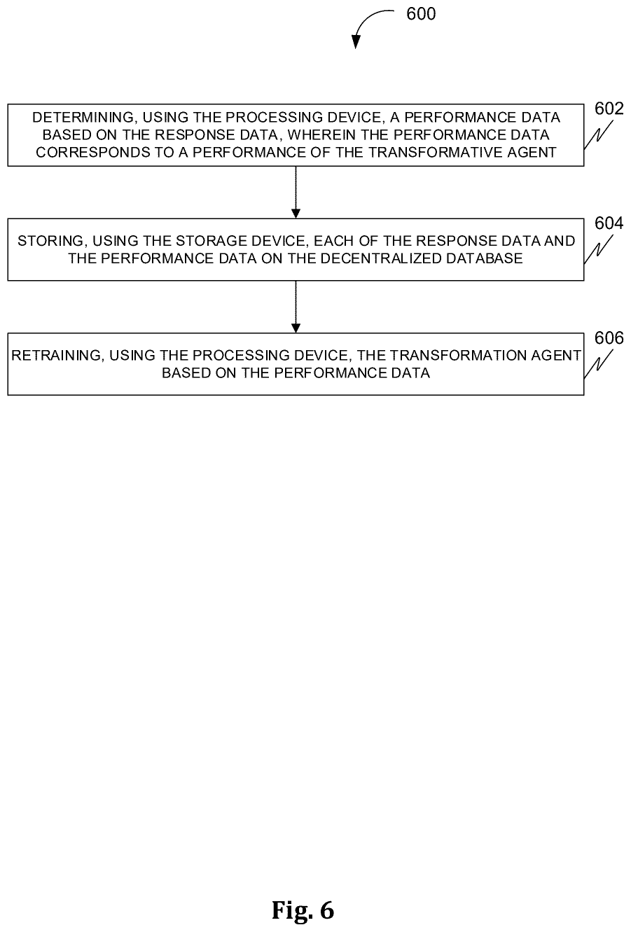

FIG. 6 illustrates a flowchart of a method 600 for facilitating decentralized management of a knowledge graph including retraining, using the processing device 1204, the transformation agent, in accordance with some embodiments.

Further, in some embodiments, the method 600 further may include a step 602 of determining, using the processing device 1204, a performance data based on the response data. Further, the performance data corresponds to a performance of the transformative agent. Further, in some embodiments, the method 600 further may include a step 604 of storing, using the storage device 1206, each of the response data and the performance data on the decentralized database. Further, in some embodiments, the method 600 further may include a step 606 of retraining, using the processing device 1204, the transformation agent based on the performance data.

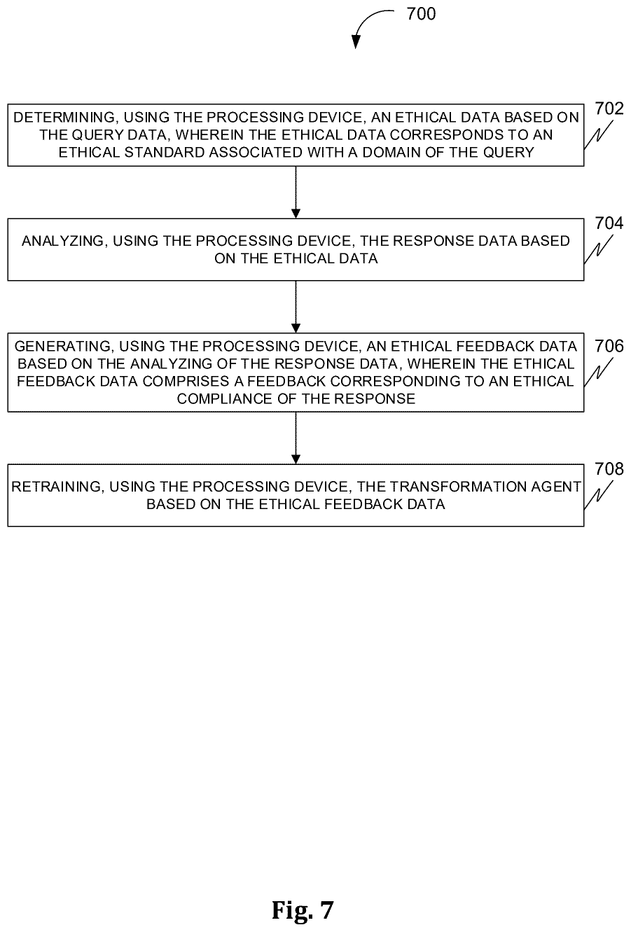

FIG. 7 illustrates a flowchart of a method 700 for facilitating decentralized management of a knowledge graph including retraining, using the processing device 1204, the transformation agent, in accordance with some embodiments.

Further, in some embodiments, the method 700 further may include a step 702 of determining, using the processing device 1204, an ethical data based on the query data. Further, the ethical data corresponds to an ethical standard associated with a domain of the query. Further, in some embodiments, the method 700 further may include a step 704 of analyzing, using the processing device 1204, the response data based on the ethical data. Further, in some embodiments, the method 700 further may include a step 706 of generating, using the processing device 1204, an ethical feedback data based on the analyzing of the response data. Further, the ethical feedback data includes a feedback corresponding to an ethical compliance of the response. Further, in some embodiments, the method 700 further may include a step 708 of retraining, using the processing device 1204, the transformation agent based on the ethical feedback data.

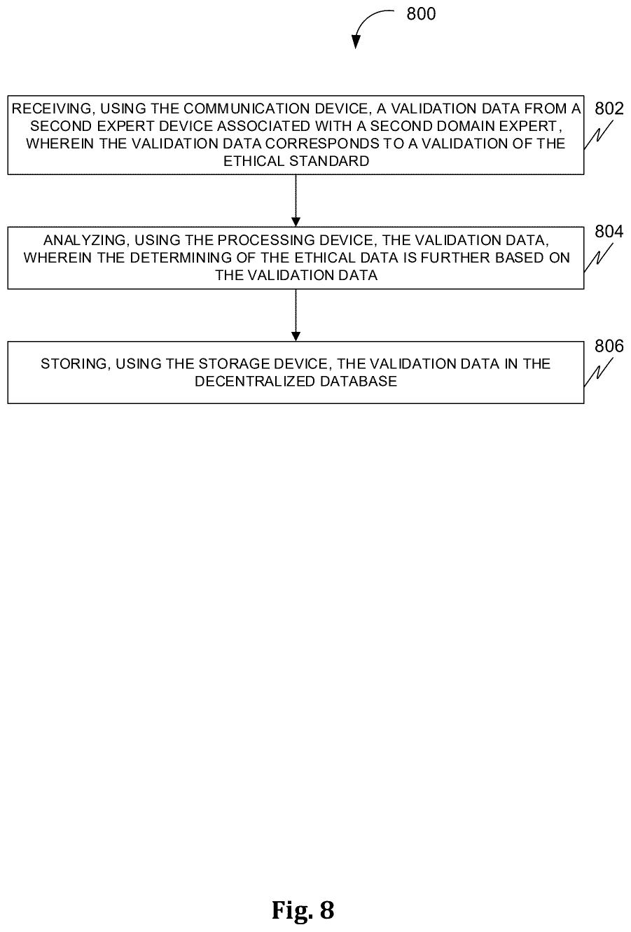

FIG. 8 illustrates a flowchart of a method 800 for facilitating decentralized management of a knowledge graph including analyzing, using the processing device 1204, the validation data, in accordance with some embodiments.

Further, in some embodiments, the method 800 further may include a step 802 of receiving, using the communication device 1202, a validation data from a second expert device associated with a second domain expert. Further, the validation data corresponds to a validation of the ethical standard. Further, in some embodiments, the method 800 further may include a step 804 of analyzing, using the processing device 1204, the validation data. Further, the determining of the ethical data may be further based on the validation data. Further, in some embodiments, the method 800 further may include a step 806 of storing, using the storage device 1206, the validation data in the decentralized database.

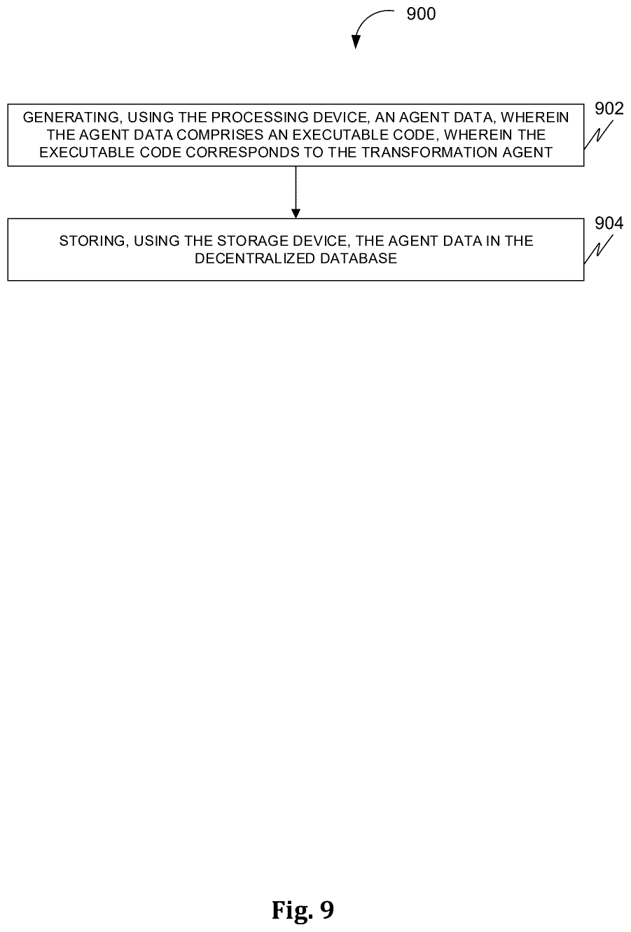

FIG. 9 illustrates a flowchart of a method 900 for facilitating decentralized management of a knowledge graph including generating, using the processing device 1204, an agent data, in accordance with some embodiments.

Further, in some embodiments, the method 900 further may include a step 902 of generating, using the processing device 1204, an agent data. Further, the agent data includes an executable code. Further, the executable code corresponds to the transformation agent. Further, in some embodiments, the method 900 further may include a step 904 of storing, using the storage device 1206, the agent data in the decentralized database.

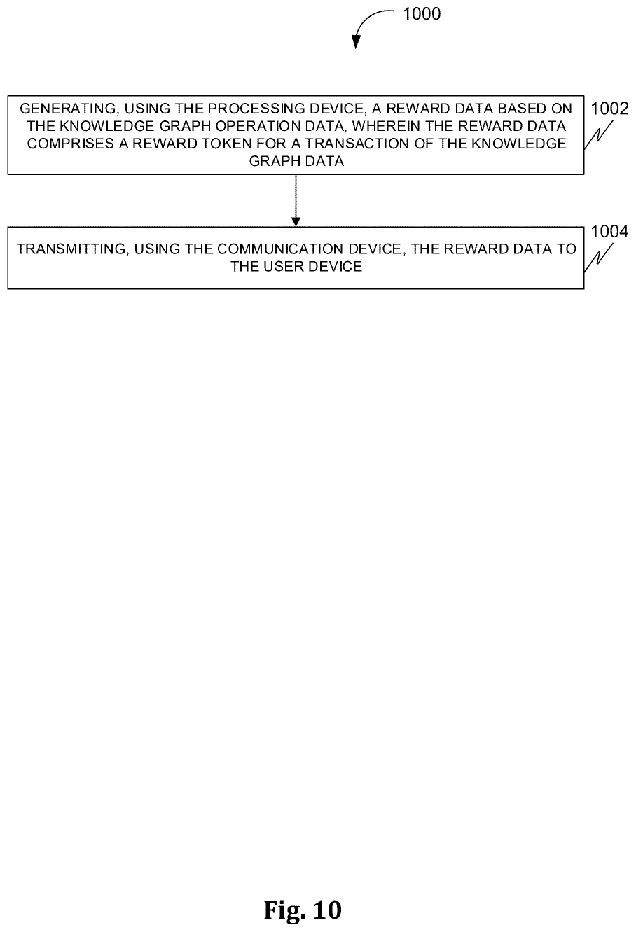

FIG. 10 illustrates a flowchart of a method 1000 for facilitating decentralized management of a knowledge graph including generating, using the processing device 1204, a reward data, in accordance with some embodiments.

Further, in some embodiments, the method 1000 further may include a step 1002 of generating, using the processing device 1204, a reward data based on the knowledge graph operation data. Further, the reward data includes a reward token for a transaction of the knowledge graph data. Further, in some embodiments, the method 1000 further may include a step 1004 of transmitting, using the communication device 1202, the reward data to the user device.

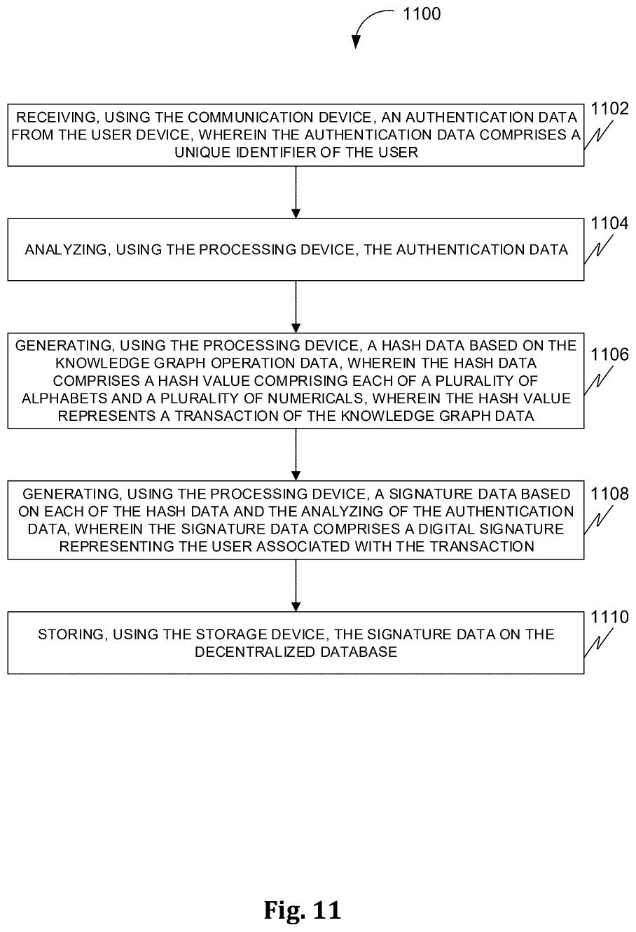

FIG. 11 illustrates a flowchart of a method 1100 for facilitating decentralized management of a knowledge graph including generating, using the processing device 1204, a signature data, in accordance with some embodiments.

Further, in some embodiments, the method 1100 further may include a step 1102 of receiving, using the communication device 1202, an authentication data from the user device. Further, the authentication data includes a unique identifier of the user. Further, in some embodiments, the method 1100 further may include a step 1104 of analyzing, using the processing device 1204, the authentication data. Further, in some embodiments, the method 1100 further may include a step 1106 of generating, using the processing device 1204, a hash data based on the knowledge graph operation data. Further, the hash data includes a hash value comprising each of two or more alphabets and two or more numericals. Further, the hash value represents a transaction of the knowledge graph data. Further, in some embodiments, the method 1100 further may include a step 1108 of generating, using the processing device 1204, a signature data based on each of the hash data and the analyzing of the authentication data. Further, the signature may data includes a digital signature representing the user associated with the transaction. Further, in some embodiments, the method 1100 further may include a step 1110 of storing, using the storage device 1206, the signature data on the decentralized database.

In some embodiments, the knowledge graph data includes a domain specific knowledge graph in a human-readable format. Further, the human-readable format includes one or more of a natural language format, a structured text format and a visual format.

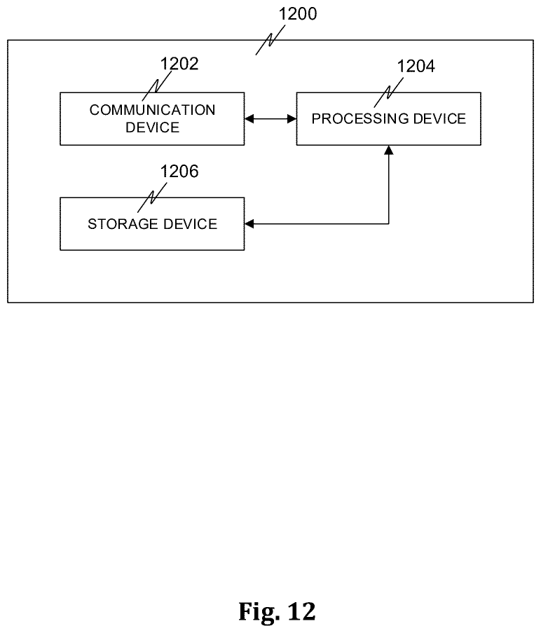

FIG. 12 illustrates a block diagram of a system 1200 for facilitating decentralized management of a knowledge graph, in accordance with some embodiments.

Accordingly, the system 1200 may include a communication device 1202. Further, the communication device 1202 may be configured for receiving a domain data from a user device associated with a user. Further, the domain data corresponds to a subject matter within a domain. Further, the system 1200 may include a processing device 1204 communicatively coupled with the communication device 1202. Further, the processing device 1204 may be configured for analyzing the domain data. Further, the processing device 1204 may be configured for generating a knowledge graph operation data based on the analyzing. Further, the knowledge graph operation data includes one or more of a creation data which may be configured for creating a knowledge graph data and an updation data which may be configured for updating the knowledge graph data. Further, the processing device 1204 may be configured for executing one or more of the creating and the updating. Further, the system 1200 may include a storage device 1206 which may be configured for storing the knowledge graph operation data on a decentralized database.

Further, in some embodiments, the communication device 1202 may be further configured for receiving a query data from a second user device associated with a second user. Further, the query data includes a query associated with the knowledge graph data. Further, the communication device 1202 may be further configured for transmitting a response data to the second user device. Further, the processing device 1204 may be further configured for instantiating a transformation agent which may be configured to access the knowledge graph data. Further, the processing device 1204 may be further configured for processing the query data based on the transformation agent. Further, the processing device 1204 may be further configured for generating the response data based on the processing. Further, the response data includes a response to the query.

In some embodiments, the communication device 1202 may be further configured for receiving a feedback data from the second user device. Further, the feedback data includes a feedback corresponding to the response data. Further, the storage device 1206 may be further configured for storing each of the response data and the feedback data on the decentralized database. Further, the processing device 1204 may be further configured for retraining the transformation agent based on the feedback data.

Further, in some embodiments, the processing device 1204 may be further configured for determining a performance data based on the response data. Further, the performance data corresponds to a performance of the transformative agent. Further, the processing device 1204 may be further configured for retraining the transformation agent based on the performance data. Further, the storage device 1206 may be further configured for storing each of the response data and the performance data on the decentralized database.

Further, in some embodiments, the processing device 1204 may be further configured for determining an ethical data based on the query data. Further, the ethical data corresponds to an ethical standard associated with a domain of the query. Further, the processing device 1204 may be further configured for analyzing the response data based on the ethical data. Further, the processing device 1204 may be further configured for generating an ethical feedback data based on the analyzing of the response data. Further, the ethical feedback data includes a feedback corresponding to an ethical compliance of the response. Further, the processing device 1204 may be further configured for retraining the transformation agent based on the ethical feedback data.

In some embodiments, the communication device 1202 may be further configured for receiving a validation data from a second expert device associated with a second domain expert. Further, the validation data corresponds to a validation of the ethical standard. Further, the processing device 1204 may be further configured for analyzing the validation data. Further, the determining of the ethical data may be further based on the validation data. Further, the storage device 1206 may be further configured for storing the validation data in the decentralized database.

In some embodiments, the processing device 1204 may be further configured for generating an agent data. Further, the agent data includes an executable code. Further, the executable code corresponds to the transformation agent. Further, the storage device 1206 may be further configured for storing the agent data in the decentralized database.

In some embodiments, the processing device 1204 may be further configured for generating a reward data based on the knowledge graph operation data. Further, the reward data includes a reward token for a transaction of the knowledge graph data. Further, the communication device 1202 may be further configured for transmitting the reward data to the user device.

Further, in some embodiments, the communication device 1202 may be further configured for receiving an authentication data from the user device. Further, the authentication data may include a unique identifier of the user. Further, the processing device 1204 may be further configured for analyzing the authentication data. Further, the communication device 1202 may be further configured for receiving an authentication data from the user device. Further, the processing device 1204 may be further configured for generating a hash data based on the knowledge graph operation data. Further, the hash data includes a hash value comprising each of two or more alphabets and two or more numericals. Further, the hash value represents a transaction of the knowledge graph data. Further, the communication device 1202 may be further configured for receiving an authentication data from the user device. Further, the processing device 1204 may be further configured for generating a signature data based on each of the hash data and the analyzing of the authentication data. Further, the signature may data includes a digital signature representing the user associated with the transaction. Further, the storage device 1206 may be further configured for storing the signature data on the decentralized database.

In some embodiments, the knowledge graph data includes a domain specific knowledge graph in a human-readable format. Further, the human-readable format includes one or more of a natural language format, a structured text format and a visual format.

In some embodiments, the knowledge graph data includes a domain-specific knowledge graph representing a relationship between two or more components of the subject matter.

In some embodiments, the generating of the knowledge graph operation data may be further based on AI model.

In some embodiments, the decentralized database may be configured to be accessible to two or more users based on two or more authentication data.

In some embodiments, the generating of the signature data includes encrypting the hash value based on the unique identifier to obtain an encrypted hash value. Further, the digital signature includes the encrypted hash value.

In some embodiments, the unique identifier includes a private key assigned to the user.

In some embodiments, the transaction represents one or more of the creating and the updating.

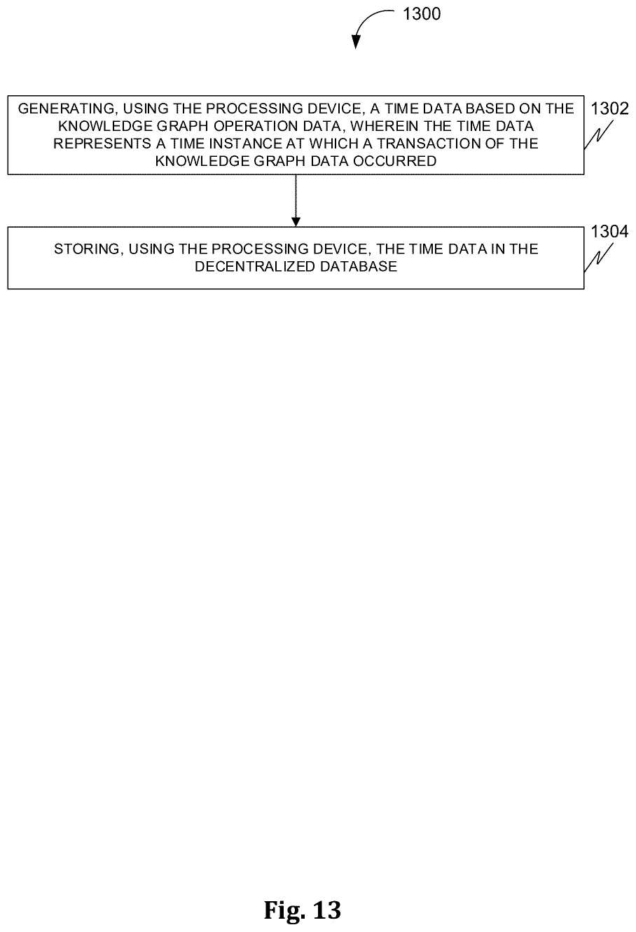

FIG. 13 illustrates a flowchart of a method 1300 for facilitating decentralized management of a knowledge graph including generating, using the processing device 1204, a time data, in accordance with some embodiments.

Further, in some embodiments, the method 1300 further may include a step 1302 of generating, using the processing device 1204, a time data based on the knowledge graph operation data. Further, the time data represents a time instance at which a transaction of the knowledge graph data occurred. Further, in some embodiments, the method 1300 further may include a step 1304 of storing, using the processing device 1204, the time data in the decentralized database.

In some embodiments, the knowledge graph data may be represented with one or more of the time value and the digital signature.

In some embodiments, the visual format corresponds to a diagram comprising one or more of two or more nodes and two or more edges.

In some embodiments, the two or more nodes represents two or more components. Further, the two or more edges represents a relationship between the two or more components.

In some embodiments, the structured text corresponds to a table representing the two or more components.

In some embodiments, the executable code includes a script based on a programming language.

In some embodiments, the programming language includes one or more of a groovy language and a python language.

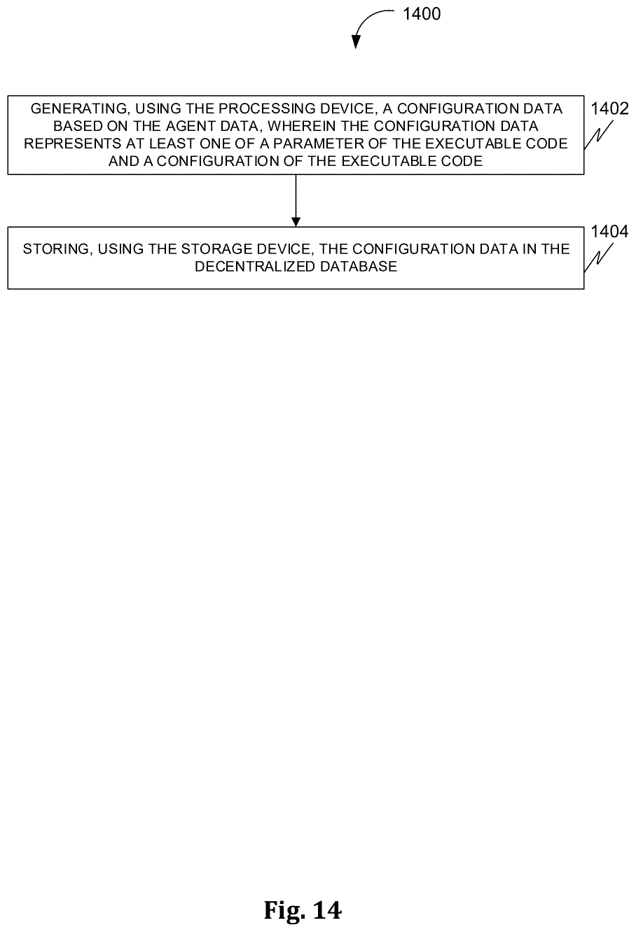

FIG. 14 illustrates a flowchart of a method 1400 for facilitating decentralized management of a knowledge graph including generating, using the processing device 1204, a configuration data, in accordance with some embodiments.

Further, in some embodiments, the method 1400 further may include a step 1402 of generating, using the processing device 1204, a configuration data based on the agent data. Further, the configuration data represents one or more of a parameter of the executable code and a configuration of the executable code. Further, in some embodiments, the method 1400 further may include a step 1404 of storing, using the storage device 1206, the configuration data in the decentralized database.

In some embodiments, the parameter corresponds to at least of an acceptable input of the executable code and an operation performable by the executable code.

In some embodiments, the decentralized database includes one or more of a first decentralized database and a second decentralized database.

In some embodiments, the first decentralized database and the second decentralized database corresponds to a main block-chain and a side block-chain respectively.

In some embodiments, each of the main block-chain and the side block-chain includes a network of plurality of blocks.

In some embodiments, the two or more authentication data based accessings of the knowledge graph data ensures one or more of an integrity of a domain specific knowledge graph and an accountability of the domain specific knowledge graph.

In some embodiments, the user includes a domain expert.

In some embodiments, the decentralized database includes two or more hash values representing two or more transactions.

In some embodiments, the reward token represents an ownership of the transaction.

In some embodiments, the reward token includes a cryptocurrency.

In some embodiments, the instantiating of the transformative agent includes one or more of a retrieving the transformative agent and compiling the transformative agent.

In some embodiments, the transformative agent may be configured to perform a task based on the knowledge graph data.

In some embodiments, the task includes solving a complex problem based on the knowledge graph data. Further, the complex problem may be associated with the domain.

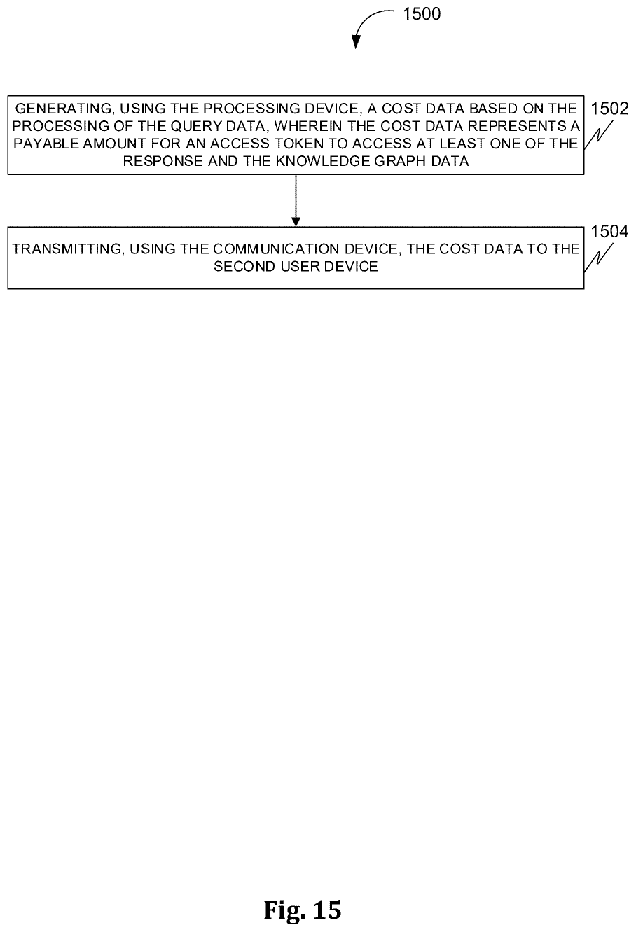

FIG. 15 illustrates a flowchart of a method 1500 for facilitating decentralized management of a knowledge graph including generating, using the processing device 1204, a cost data, in accordance with some embodiments.

Further, in some embodiments, the method 1500 further may include a step 1502 of generating, using the processing device 1204, a cost data based on the processing of the query data. Further, the cost data represents a payable amount for an access token to access one or more of the response and the knowledge graph data. Further, in some embodiments, the method 1500 further may include a step 1504 of transmitting, using the communication device 1202, the cost data to the second user device.

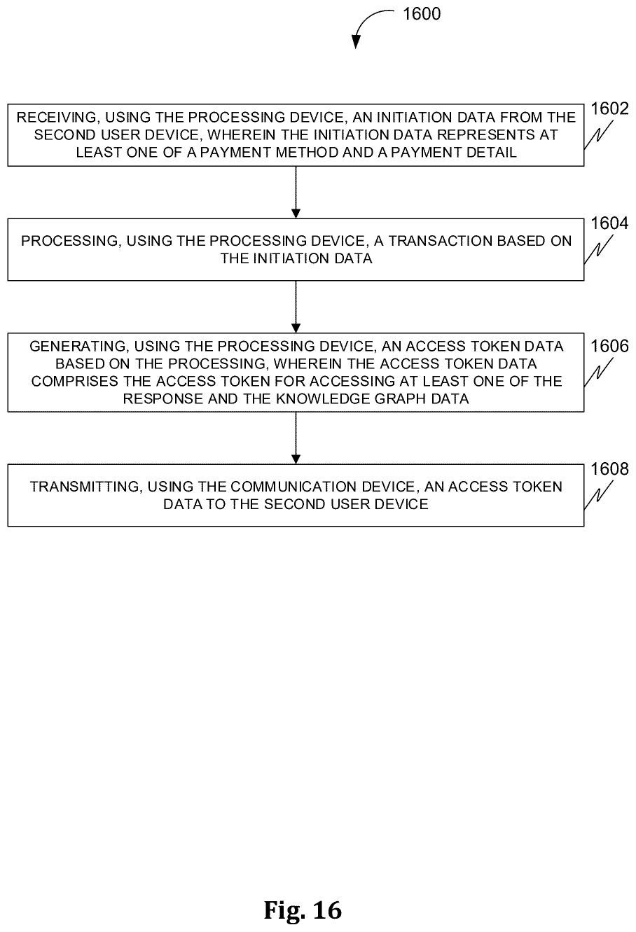

FIG. 16 illustrates a flowchart of a method 1600 for facilitating decentralized management of a knowledge graph including generating, using the processing device 1204, an access token data, in accordance with some embodiments.

Further, in some embodiments, the method 1600 further may include a step 1602 of receiving, using the processing device 1204, an initiation data from the second user device. Further, the initiation data represents one or more of a payment method and a payment detail. Further, in some embodiments, the method 1600 further may include a step 1604 of processing, using the processing device 1204, a transaction based on the initiation data. Further, in some embodiments, the method 1600 further may include a step 1606 of generating, using the processing device 1204, an access token data based on the processing. Further, the access token data includes the access token for accessing one or more of the response and the knowledge graph data. Further, in some embodiments, the method 1600 further may include a step 1608 of transmitting, using the communication device 1202, an access token data to the second user device.

In some embodiments, the access token data includes two or more access tokens for accessing one or more of the response and the knowledge graph data at two or more time instances over a time interval.

In some embodiments, the processing of the query data includes determining one or more of a complexity of the response and an operation associated with the response. Further, the payable amount may be further based on one or more of the complexity and the operation.

In some embodiments, the method 1500 may further include generating, using the processing device 1204, a usage metric data based on the response data. Further, the usage metric data includes a metric corresponding a parameter associated with the response data. Further, the generating of the cost data may be further based on the usage metric data.

In some embodiments, the parameter includes a time duration of a second user engagement with the transformation agent.

In some embodiments, the metric includes a real-time usage metric.

In some embodiments, the generating of the reward data may be further based on an executing of an executable agreement code which may be configured to execute based on a predetermined agreement.

In some embodiments, the predetermined agreement represents a requirement for the reward token.

In some embodiments, the executable agreement code may be stored in the decentralized database.

In some embodiments, the generating of the access token data may be further based on an executing of the executable agreement code, the predetermined agreement represents the requirement for the access token.

In some embodiments, the executable agreement code may be configured to deduct a count of the access token based on the second user engagement with one or more of the response data and the knowledge graph data.

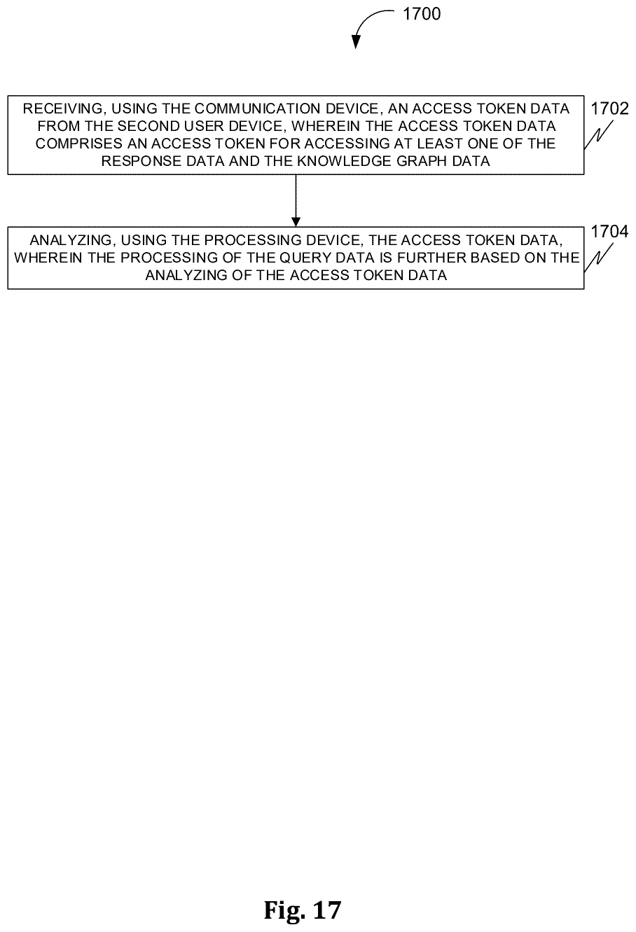

FIG. 17 illustrates a flowchart of a method 1700 for facilitating decentralized management of a knowledge graph including analyzing, using the processing device 1204, the access token data, in accordance with some embodiments.

Further, in some embodiments, the method 1700 further may include a step 1702 of receiving, using the communication device 1202, an access token data from the second user device. Further, the access token data includes an access token for accessing one or more of the response data and the knowledge graph data. Further, in some embodiments, the method 1700 further may include a step 1704 of analyzing, using the processing device 1204, the access token data. Further, the processing of the query data may be further based on the analyzing of the access token data.

In some embodiments, the validation data includes two or more validation data received from two or more expert devices.

In some embodiments, the two or more validation data includes two or more validations comprising two or more votes.

In some embodiments, the determining of the ethical data may be based on a voting mechanism.

In some embodiments, the determining based on the analyzing of the two or more validation data facilitates a decentralized governance.

In some embodiments, the transformation agent may be configured to adapt based on the ethical feedback data.

In some embodiments, the ethical standard corresponds to one or more of a moral dilemma, a logical fallacy and a sample argument.

In some embodiments, the analyzing of the response data may be further based on one or more of an Aristotelian logic, a Socratic dialectic inquiry, and a Wittgensteinian language game.

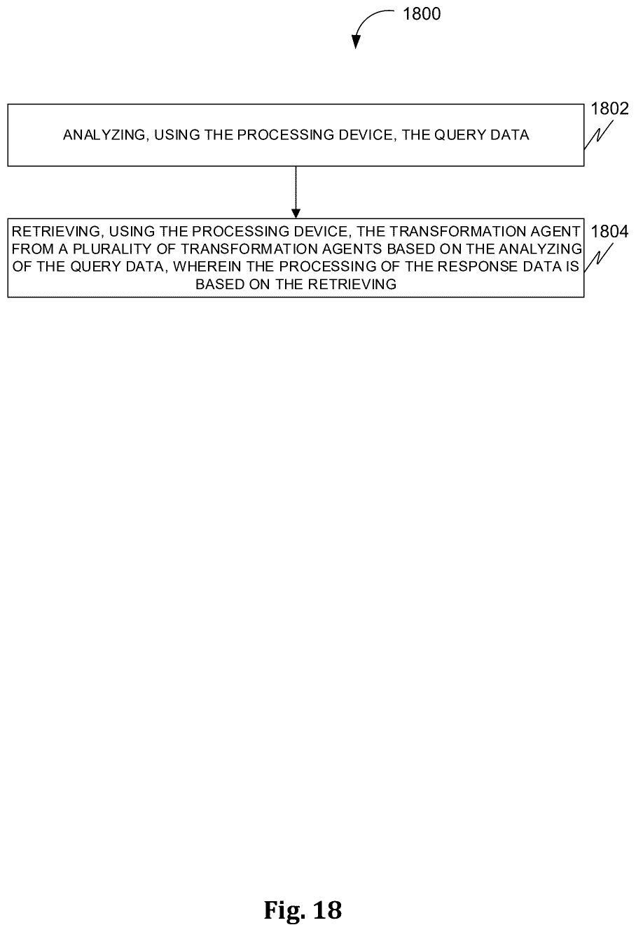

FIG. 18 illustrates a flowchart of a method 1800 for facilitating decentralized management of a knowledge graph including retrieving, using the processing device 1204, the transformation agent from a plurality of transformation agents, in accordance with some embodiments.

Further, in some embodiments, the method 1800 further may include a step 1802 of analyzing, using the processing device 1204, the query data. Further, in some embodiments, the method 1800 further may include a step 1804 of retrieving, using the processing device 1204, the transformation agent from two or more transformation agents based on the analyzing of the query data. Further, the processing of the response data may be based on the retrieving.

In some embodiments, the performance data corresponds to the retrieving of the transformative agent.

In some embodiments, the processing of the query data may be based on two or more transformative agents. Further, the performance data corresponds to a refinement of a combination of the two or more transformative agents.

In some embodiments, the transformative agent may be configured for an adaptive learning based on the feedback data. Further, the adaptive learning facilitates a dynamic response generation.

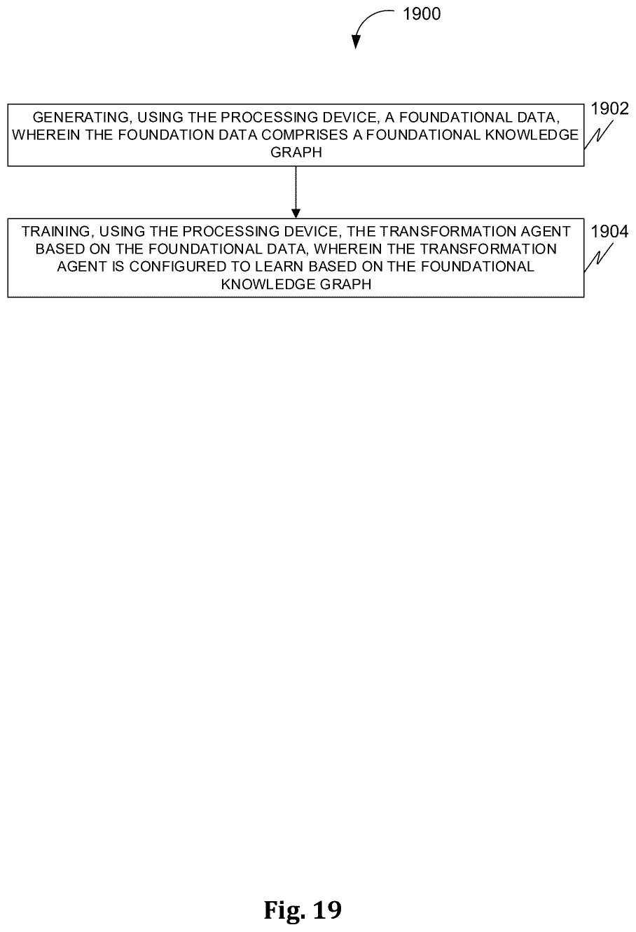

FIG. 19 illustrates a flowchart of a method 1900 for facilitating decentralized management of a knowledge graph including training, using the processing device 1204, the transformation agent, in accordance with some embodiments.

Further, in some embodiments, the method 1900 further may include a step 1902 of generating, using the processing device 1204, a foundational data. Further, the foundation data includes a foundational knowledge graph. Further, in some embodiments, the method 1900 further may include a step 1904 of training, using the processing device 1204, the transformation agent based on the foundational data. Further, the transformation agent may be configured to learn based on the foundational knowledge graph.

In some embodiments, the foundational knowledge graph includes one or more of an abstraction and reasoning corpus puzzle knowledge graph and a mathematics knowledge graph.

In some embodiments, the foundation data further includes a puzzle derived from one or more of a training dataset and an evaluation dataset.

In some embodiments, the analyzing of the domain data may be based on a large language model.

In some embodiments, the method 400 may further include generating, using the processing device 1204, a command data based on the query data. Further, the command data includes a cypher command. Further, the processing of the query data includes processing of the command data.

In some embodiments, the method 700 may further include receiving, using the communication device 1202, a modified ethical data from the user device. Further, the modified ethical data includes a modified ethical standard. Further, the analyzing of the response data may be further based on the modified ethical data.

In some embodiments, the validation data corresponds to the validation of a parameter associated with the transformative agent.

In some embodiments, the method 400 may be further include retrieving, using the processing device 1204, a contextual data based on the processing. Further, the contextual data includes an external detail corresponding to the query. Further, the generating of the response data may be further based on the contextual data.

In some embodiments, the contextual data may be retrieved form an external database through an application programing interface.

In some embodiments, the external database corresponds to an enterprise.

In some embodiments, the method 700 may further include transmitting, using the communication device 1202, the ethical feedback data to the user device. Further, the ethical feedback data represents a non-compliance of the response data for an expert review.

In some embodiments, the method 1600 may be the executable agreement code may be configured to automate a micro transaction.

In some embodiments, the method 600 may further include generating, using the processing device 1204, a modified agent data based on one or more of the performance data and the feedback data. Further, the modified agent data includes a modified executable code of the transformation agent. Further, the generating of the response data at a second time instance may be based on the modified executable code. Further, each of the performance data and the feedback data may be based on the response data generated at the first time instance.

In some embodiments, the second time instance occurred later than the first time instance.

In some embodiments, the query data corresponds to one or more of an abstract puzzle, a complex mathematical problem, and an ethical language game.

In some embodiments, the generating of the hash data may be based on a cryptographic hash function.

In some embodiments, the cryptographic hash function includes a secure hash algorithm.

In some embodiments, the method 1700 may further include storing, using the processing device 1204, the access token data in the decentralized database.

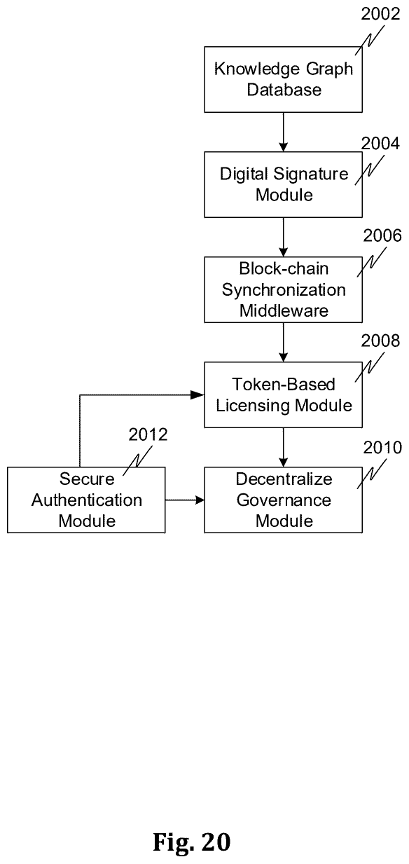

FIG. 20 illustrates a system architecture, in accordance with some embodiments. Further, the system includes a knowledge graph database 2002 to store domain-specific data as a knowledge graph comprising an interconnected node and edge. Further, knowledge graph transaction is digitally signed and timestamped. Further, the system includes a digital signature module 2004 for generating digital signature for knowledge graph transaction based on a public key infrastructure. Further, the system includes a block-chain synchronization module 2006 for one or more of aggregating knowledge graph transaction and computing a cryptographic hash. Further, the system includes a token-based licensing module 2008 for calculating token cost based on real-time usage metric. Further, the system includes a decentralized governance module 2010 for providing a voting mechanism through which domain experts can validate the knowledge graph. Further, the system includes a secure authentication module 2012 for implementing multi-factor authentication.

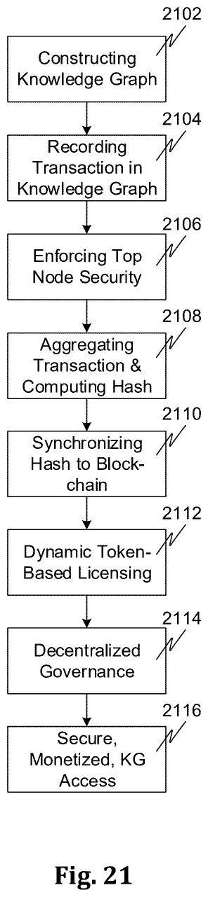

FIG. 21 illustrates a flowchart of decentralized management of a knowledge graph, in accordance with some embodiments. Further, the decentralized management include one or more of a step 2102 of constructing a knowledge graph, a step 2104 of recording a transaction in knowledge graph, a step 2106 of enforcing a top node security, a step 2108 of one or more of aggregating the transaction and computing a hash, a step 2110 of synchronizing the hash to block-chain, a step 2112 of dynamic token-based licensing, a step 2114 of decentralized governance, and a step 2116 of securing and monetizing an access of the knowledge graph.

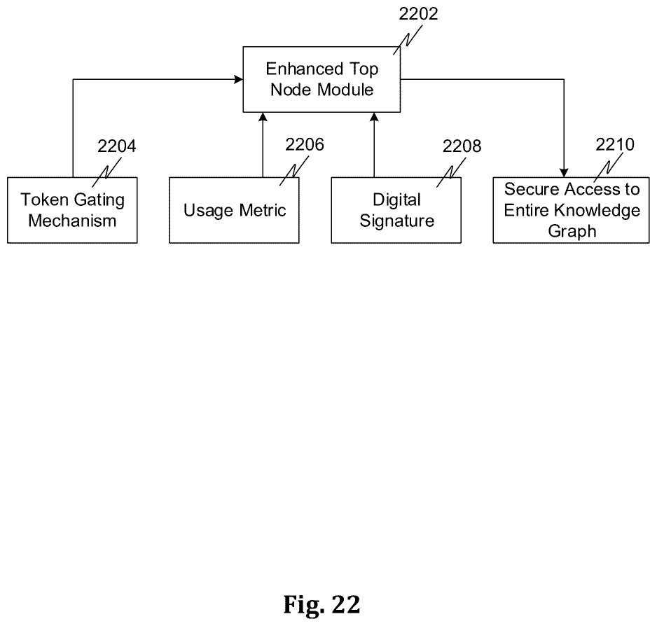

FIG. 22 illustrates a top node schematic of decentralized management of a knowledge graph, in accordance with some embodiments. Further, an enhanced top node module 2202 may utilize one of more of a token gating mechanism 2204, a usage metric 2206, and a digital signature 2208. Further, the enhanced top node module 2202 facilitates a secure access to a knowledge graph 2210.

Although the invention has been explained in relation to its preferred embodiment, it is to be understood that many other possible modifications and variations can be made without departing from the spirit and scope of the invention as hereinafter claimed.

1. A method for facilitating decentralized management of a knowledge graph, the method comprising:
receiving, using a communication device, a domain data from a user device associated with a user, wherein the domain data corresponds to a subject matter within a domain;
analyzing, using a processing device, the domain data;
generating, using the processing device, a knowledge graph operation data based on the analyzing, wherein the knowledge graph operation data comprises at least one of a creation data configured for creating a knowledge graph data and an updation data configured for updating the knowledge graph data;
executing, using the processing device, at least one of the creating and the updating; and
storing, using a storage device, the knowledge graph operation data on a decentralized database.

2. The method of claim 1 further comprising:
instantiating, using the processing device, a transformation agent configured to access the knowledge graph data;
receiving, using the communication device, a query data from a second user device associated with a second user, wherein the query data comprises a query associated with the knowledge graph data;
processing, using the processing device, the query data based on the transformation agent;
generating, using the processing device, a response data based on the processing, wherein the response data comprises a response to the query; and
transmitting, using the communication device, the response data to the second user device.

3. The method of claim 2 further comprising:
receiving, using the communication device, a feedback data from the second user device, wherein the feedback data comprises a feedback corresponding to the response data;
storing, using the storage device, each of the response data and the feedback data on the decentralized database; and
retraining, using the processing device, the transformation agent based on the feedback data.

4. The method of claim 2 further comprising:
determining, using the processing device, a performance data based on the response data, wherein the performance data corresponds to a performance of the transformative agent;
storing, using the storage device, each of the response data and the performance data on the decentralized database; and
retraining, using the processing device, the transformation agent based on the performance data.

5. The method of claim 2 further comprises:
determining, using the processing device, an ethical data based on the query data, wherein the ethical data corresponds to an ethical standard associated with a domain of the query;
analyzing, using the processing device, the response data based on the ethical data;
generating, using the processing device, an ethical feedback data based on the analyzing of the response data, wherein the ethical feedback data comprises a feedback corresponding to an ethical compliance of the response; and
retraining, using the processing device, the transformation agent based on the ethical feedback data.

6. The method of claim 5 further comprises:
receiving, using the communication device, a validation data from a second expert device associated with a second domain expert, wherein the validation data corresponds to a validation of the ethical standard; and
analyzing, using the processing device, the validation data, wherein the determining of the ethical data is further based on the validation data; and
storing, using the storage device, the validation data in the decentralized database.

7. The method of claim 2 further comprises:
generating, using the processing device, an agent data, wherein the agent data comprises an executable code, wherein the executable code corresponds to the transformation agent; and
storing, using the storage device, the agent data in the decentralized database.

8. The method of claim 1 further comprises:
generating, using the processing device, a reward data based on the knowledge graph operation data, wherein the reward data comprises a reward token for a transaction of the knowledge graph data; and
transmitting, using the communication device, the reward data to the user device.

9. The method of claim 1 further comprises:
receiving, using the communication device, an authentication data from the user device, wherein the authentication data comprises a unique identifier of the user;
analyzing, using the processing device, the authentication data;
generating, using the processing device, a hash data based on the knowledge graph operation data, wherein the hash data comprises a hash value comprising each of a plurality of alphabets and a plurality of numericals, wherein the hash value represents a transaction of the knowledge graph data;
generating, using the processing device, a signature data based on each of the hash data and the analyzing of the authentication data, wherein the signature data comprises a digital signature representing the user associated with the transaction; and
storing, using the storage device, the signature data on the decentralized database.

10. The method of claim 1, wherein the knowledge graph data comprises a domain specific knowledge graph in a human-readable format, wherein the human-readable format comprises at least one of a natural language format, a structured text format and a visual format.

11. A system for facilitating decentralized management of a knowledge graph, the system comprising:
a communication device configured for:
receiving a domain data from a user device associated with a user, wherein the domain data corresponds to a subject matter within a domain;
a processing device configured for:
analyzing the domain data;
generating a knowledge graph operation data based on the analyzing, wherein the knowledge graph operation data comprises at least one of a creation data configured for creating a knowledge graph data and an updation data configured for updating the knowledge graph data;
executing at least one of the creating and the updating; and
a storage device configured for storing the knowledge graph operation data on a decentralized database.

12. The system of claim 11, wherein the communication device is further configured for:
receiving a query data from a second user device associated with a second user, wherein the query data comprises a query associated with the knowledge graph data;
transmitting a response data to the second user device, wherein the processing device is further configured for:
instantiating a transformation agent configured to access the knowledge graph data;
processing the query data based on the transformation agent; and
generating the response data based on the processing, wherein the response data comprises a response to the query.

13. The system of claim 12, wherein the communication device is further configured for receiving a feedback data from the second user device, wherein the feedback data comprises a feedback corresponding to the response data, wherein the storage device is further configured for storing each of the response data and the feedback data on the decentralized database, wherein the processing device is further configured for retraining the transformation agent based on the feedback data.

14. The system of claim 12, wherein the processing device is further configured for:
determining a performance data based on the response data, wherein the performance data corresponds to a performance of the transformative agent; and
retraining the transformation agent based on the performance data, wherein the storage device is further configured for storing each of the response data and the performance data on the decentralized database.

15. The system of claim 12, wherein the processing device is further configured for:
determining an ethical data based on the query data, wherein the ethical data corresponds to an ethical standard associated with a domain of the query;
analyzing the response data based on the ethical data;
generating an ethical feedback data based on the analyzing of the response data, wherein the ethical feedback data comprises a feedback corresponding to an ethical compliance of the response; and
retraining the transformation agent based on the ethical feedback data.

16. The system of claim 15, wherein the communication device is further configured for receiving a validation data from a second expert device associated with a second domain expert, wherein the validation data corresponds to a validation of the ethical standard, wherein the processing device is further configured for analyzing the validation data, wherein the determining of the ethical data is further based on the validation data, wherein the storage device is further configured for storing the validation data in the decentralized database.

17. The system of claim 12, wherein the processing device is further configured for generating an agent data, wherein the agent data comprises an executable code, wherein the executable code corresponds to the transformation agent, wherein the storage device is further configured for storing the agent data in the decentralized database.

18. The system of claim 11, wherein the processing device is further configured for generating a reward data based on the knowledge graph operation data, wherein the reward data comprises a reward token for a transaction of the knowledge graph data, wherein the communication device is further configured for transmitting the reward data to the user device.

19. The system of claim 11, wherein the communication device is further configured for receiving an authentication data from the user device, wherein the authentication data comprises a unique identifier of the user, wherein the processing device is further configured for:
analyzing the authentication data;
generating a hash data based on the knowledge graph operation data, wherein the hash data comprises a hash value comprising each of a plurality of alphabets and a plurality of numericals, wherein the hash value represents a transaction of the knowledge graph data; and
generating a signature data based on each of the hash data and the analyzing of the authentication data, wherein the signature data comprises a digital signature representing the user associated with the transaction, wherein the storage device is further configured for storing the signature data on the decentralized database.

20. The system of claim 11, wherein the knowledge graph data comprises a domain specific knowledge graph in a human-readable format, wherein the human-readable format comprises at least one of a natural language format, a structured text format and a visual format.
